(19) United States
(12) Patent Application Publication
(10) Pub. No.: US 2023/0198105 A1
(43) Pub. Date: Jun. 22, 2023

(54) ELECTRONIC COMPONENT FOR A CELL-CONTACTING SYSTEM, CELL CONTACTING SYSTEM, AND METHOD FOR PRODUCING THE CELL CONTACTING SYSTEM OR A BATTERY MODULE

(71) Applicant: Diehl Advanced Mobility GmbH, Zehdenick (DE)

(72) Inventors: Jürgen Weyh, Viernau (DE); Martin Wieberger, Berlin (DE); Ingo Weber, Potsdam (DE); Dario Kremser, Schönfliess (DE)

(21) Appl. No.: 18/173,117

(22) Filed: Feb. 23, 2023

Related U.S. Application Data
(63) Continuation of application No. PCT/EP2021/071233, filed on Jul. 29, 2021.

(30) Foreign Application Priority Data
Aug. 27, 2020 (DE) 10 2020 005 235.5

(51) Int. Cl. H01M 50/519; H01R 12/58; H01R 43/02

(52) U.S. Cl. CPC H01M 50/519; H01R 12/58; H01R 43/0221

(57) ABSTRACT

An electronic component for a cell-contacting system with cell connectors is used for power contacting of battery cells of a battery. The component contains a circuit board of a measurement and/or management assembly for the battery, and has plug receptacles for connection to the cell connectors, a support frame with receptacle for the circuit board, electrical connection elements for connection of the circuit board and the cell connectors to plug contacts, embedded in the support frame, for the plug receptacles. The circuit board is insertable into the receptacle by plugging the plug receptacles with the plug contacts and has a communication interface. A cell-contacting system with cell connectors contains at least one electronic component. When producing a cell-contacting system, the electrical connection elements are firstly connected to the cell connectors and the circuit board is then inserted into the receptacle.

### CROSS-REFERENCE TO RELATED APPLICATION

This application is a continuation, under 35 U.S.C. § 120, of copending International Patent Application PCT/EP2021/071233, filed Jul. 29, 2021, which designated the United States; this application also claims the priority, under 35 U.S.C. § 119, of German Patent Application DE 10 2020 005 235.5, filed Aug. 27, 2020; the prior applications are herewith incorporated by reference in their entirety.

### FIELD AND BACKGROUND OF THE INVENTION

The invention relates to cell-contacting systems for electrical energy-storage devices, in this case in particular batteries, in particular traction batteries for electrically driven motor vehicles.

Electrical energy-storage devices are used for the storage or temporary storage of electrical energy. Such energy-storage devices can comprise, for example, accumulator or battery packs with a plurality of cells, i.e. battery or accumulator cells. Such energy-storage devices are referred to within the sense of the present patent application for the sake of simplicity generally as “batteries”. Such batteries find application in particular as traction or driving batteries for electric motor vehicles.

Cell-contacting systems are connecting systems which serve to electrically connect individual cells of the battery, in particular accumulator or battery cells or batteries consisting of a plurality of cells, to one another. The individual cells or groups of cells are interconnected by corresponding cell-contacting systems such that a desired target voltage is made available at connectors or tapping points of the cell-contacting systems.

The cell-contacting systems here generally also contain means for monitoring both the individual cells and the whole battery, for example in terms of temperatures, voltages, and currents and for managing them in charging or discharging mode. Such means are in particular sensor lines, sensors, or alternatively electronic switches.

For example, a connecting system for an energy-storage device is known from European patent EP 2 639 857 B1 (corresponding to U.S. patent publication No. 2013/0244499), wherein the energy-storage device has a plurality of cells, with a plurality of cell connectors, retained by a support system, for electrically interconnecting the cells, with a storage control unit for monitoring an energy reserve and/or charging state of the cells. The support system is designed to accommodate and/or retain the storage control unit, and the storage control unit is designed so that it is integrated with the support system or can be detached therefrom. A support part comprised by the support system has an interface and/or holder for the storage control unit.

### SUMMARY OF THE INVENTION

The object of the present invention is to propose improvements with respect to a cell-contacting system.

The object is achieved by an electronic component according to main independent patent claim for a cell-contacting system. Preferred or advantageous embodiments of the invention and other categories of the invention can be found in the further claims, the following description, and the attached figures.

The cell-contacting system is in particular one suitable for a traction battery of an electrically driven motor vehicle.

The invention is based on the fact that the cell-contacting system has a plurality of cell connectors which serve for power contacting battery cells of a battery. This means that the battery power is removed from the latter or fed into it via the cell connectors. In particular, the electronic component is configured with regard to a cell-contacting system for the intended purpose. “For the intended purpose” means that the electronic component is structurally compatible with a specific or a specific type of cell-contacting system or battery and is provided for use there; for example, is designed for the geometrical requirements, power requirements, etc.

Within the sense of the abovementioned suitability for the intended purpose, within the application properties of cell-contacting systems and batteries are therefore also described although, strictly speaking, the actual components are not part of but are the subject of the respective invention. However, these statements also apply, mutatis mutandis, for the cell-contacting systems and batteries described below and may not be explicitly repeated again there.

In particular, a (at least later, in the mounted state) fixed and known geometrical relative position of the cell connectors relative to one another or in the cell-contacting system is therefore also known, at least when the cell-contacting system is connected as intended to the battery.

The cell connectors can form a cell pole connector series. This cell pole connector series can have, for example, a plurality of cell pole connectors, arranged in particular one behind the other in parallel to a longitudinal axis or transverse axis of the electronic component. A cell pole connector is expediently designed for electrically interconnecting in each case at least two cell poles of battery cells of the battery.

The electronic component contains a printed circuit board of a measuring and/or management arrangement for the battery, wherein each of the printed circuit boards has plug-in sockets for electrically connecting the printed circuit board (and its lines/components) to the cell connectors. The electronic component contains at least one support frame which can be arranged or is arranged in the mounted state in particular between the cell connectors and has a holder for the printed circuit board. The printed circuit board can here in particular also be configured with multiple parts.

The electronic component contains a plurality of in particular single-pole electrical connecting elements for respectively electrically connecting the printed circuit board (or plug-in sockets) to the cell connectors. Each connecting element here has one plug-in contact in particular on one side, facing the printed circuit board. The plug-in contact can be plugged in an electrically contacting fashion to one of the plug-in sockets. In particular, the plugging process takes place in such a way that the connection can be released again and replugged together later. Alternatively, however, once the plug-in connection has been produced it cannot be released. Each of the plug-in contacts is preferably embedded in the support frame and consequently mechanically firmly fastened to the latter. In an alternative embodiment, the plug-in contacts can also be embedded in a cover associated with the support frame and hence embedded directly in the support frame and fastened to the latter. The support frame is manufactured in particular from plastic, as is any cover that is provided. The embedding of the plug-in contacts can here be affected, for example, by being injected into the plastic. It is also possible for the embedding to be effected by means of sealing to the support frame or to a cover associated with the support frame. In particular, the plug-in contact is configured as a male connector and the plug-in socket as a female connector, but the reverse can also be possible. It is, however, also conceivable that the plug-in contacts, facing the printed circuit board, of the connecting elements are passed through openings in the support frame or in a cover associated with the support frame into the region of the holder or are passed via their connecting element over the edge of the support frame into the region of the holder in order to enable them to be plugged to the plug-in sockets of the printed circuit board.

The printed circuit board can be inserted into the holder, wherein the plug-in contacts are thus plugged (in particular simultaneously or automatically with the insertion) into or with the plug-in sockets.

The printed circuit board moreover has at least one communications interface for the data exchange of information with a respective remote station. Information is any information that is useful or necessary for battery management, in particular on currents, voltages, and temperatures of the contacted battery in the mounted state of the battery or when it is in operation.

Starting from the printed circuit board, communication can here take place in one or both directions (incoming/outgoing). The remote station can be a communications interface of a different printed circuit board (in particular a different electronic component) or a remote station inside or outside the cell-contacting system, for example an external evaluation unit, central control system, etc.

In particular, measurement signals from the battery (voltages, currents, temperatures, etc.) are received or generated on the printed circuit board. In particular, conversion of such measurement signals into a data-transmission signal takes place on the printed circuit board in order to transmit said signal via the communications interface.

The cell connectors which do not belong to the electronic component are in particular not embedded in the support frame, molded, melted to the latter, etc. In any case, the support frame is here plugged onto cell connectors or fastened to the latter in a different fashion.

According to the invention, a printed circuit board, which performs electrical relaying/processing of measurement signals, is introduced/integrated into the cell-contacting system. The cell-contacting system with the electronic components (printed circuit board, etc.) is expanded by the communications interface such that a data-transmission system (wired or wireless) can be used for communication between individual printed circuit boards or cells of a module and between multiple battery modules.

According to the invention, the printed circuit board or boards is or are surrounded by a support frame, in particular a plastic frame, into which plug-in contacts, in particular press-fit pins (or PTH pins) are embedded in order to be able to contact the cell connectors to the printed circuit board by means of the connecting elements (in particular indirectly via a copper enameled wire or directly to a conductor bridge). The support frame surrounds the edge of the printed circuit board after the latter has been inserted, preferably completely, into the holder of the support frame.

According to the invention, it is possible to carry out mounting of the printed circuit board (PCB) only once the cell-contacting system (CCS) has been welded to the battery (cell). By virtue of the pluggability, in particular the use of press-fit techniques, it is possible to insert the in particular rigid printed circuit board into the CCS as the last mounting step and also only once all the preceding process steps have been successfully completed. By virtue of the pluggability, in particular the use of press-fit technology, there is minimal thermal and mechanical stress during the mounting of the printed circuit board.

The optional wiring of a copper enameled wire as a contact means allows thermal movements in the cell-contacting system by virtue of resiliency and 3D mobility. This is to be understood as meaning that the wire can compensate movements, displacements of its ends or fixing points in all three spatial directions, i.e. in 3D, or be resilient in response to them. This is achieved in particular by the wire running in a curving or bridge-like fashion or with a U-shape or S-shape. The same also applies for the shape of the connecting elements. Data transmission in the CCS itself and between the CCS and a remote station/evaluation unit etc. can be designed as desired.

According to the invention, an electronic component (printed circuit board with corresponding components) is integrated into the cell-contacting system and converts the measurement signals of the signal lines (connecting elements) into a signal (for example, digital signal) which can be used for data transmission systems (transmission via the communications interface). This results in the possibility of integrating a data transmission system (for example, a wired or wireless BUS) into the CCS. It is possible to freely adapt to the number of cells in a battery by using the optional wiring techniques. The use of overmolded lead frames (for the plug-in contacts/connecting elements) is possible. A holder of the PCB can be formed such that the PCB/FPC (flexible printed circuit)/RFPC (rigid-flex printed circuit), or alternatively a combination thereof, can also still be held after the CCS has been mounted in the battery system or after the CCS itself has been mounted.

The invention is based on the realization that electromechanical line systems are used in the products (cell-contacting systems) currently known from the prior art for relaying signals. The processing of signals is usually effected externally (i.e. outside the CCS). Sensors are attached directly on the components to be monitored, separate from the processing electronics. Similar (measurement) signals are made by means of FPCs or copper conductors with plug-in connectors. The control unit/PCB is usually arranged externally.

According to the invention, there is an alternative to the existing solutions known from the prior art for relaying physical status variables from and between battery components to a decentralized signal evaluation system or processing system without cabling the individual components. Separate submodules and sensor systems are functionally integrated.

Electronics are integrated into cell-contacting systems (single-/multi-cell design). There are electronics with temperature measurement on cell connectors and a press-fit housing. Cell-contacting systems are expanded by one or more electrically conductive components which enable the relaying and interconnecting of signal and sensor lines inside battery systems for further processing.

In a preferred embodiment of the invention, at least one of the plug-in contacts is a press-fit pin or a PTH pin (plated through hole). Such pins as plug-in contacts are commercially available and offer a reliable and simple contacting means.

In a preferred embodiment of the invention, at least one of the connecting elements is a one-piece direct connector between the printed circuit board and the cell connectors. In particular, the direct connector is equipped with thermal length compensation, for example a bridge-like multiply angled design and spring properties, i.e. a “spring bridge”. The direct connector is in particular manufactured as a single part, a solid piece of material with in particular no joints. A particularly simple embodiment thus results.

In a preferred embodiment of the invention, at least one of the connecting elements is configured with multiple parts and contains a fixed section, facing the printed circuit board, with the plug-in contact, and a wire section facing the cell connector. The wire section contains at least one wire holder, connected to the fixed section, in particular a clamping fork/tuning fork contact, for a connecting wire and the connecting wire leading from the wire holder to the cell connector. The connecting element is therefore manufactured from multiple parts. Even if a materially bonded connection should be created here in the mounted state, a join is then formed in contrast to the above one-piece embodiment. The connecting wire is in particular an enameled wire, in particular a copper enameled wire. Simple adaptation to mounting circumstances is in particular possible by virtue of the wiring. The wire is in particular sufficiently flexible per se to ensure thermal or mechanical (vibrations, movements) length compensation between the fixed section and the cell connector.

In a preferred embodiment of the invention, the support frame is fastened in a mounted state in the cell-contacting system only by means of the connecting elements mechanically on the cell connectors and/or on a support structure which in turn supports, holds, or fixes the cell connectors themselves, and consequently is fastened in the cell-contacting system. The support frame then does not have to be held separately mechanically.

In particular, the printed circuit board is correspondingly held on the support frame both electrically and mechanically solely by being plugged onto the plug-in contacts. Here too, there is no need for the printed circuit board to be fastened to the support frame or another holding structure in any other way. The printed circuit board can then be plugged onto the plug-in contacts so that it makes both electrical contact and a mechanical connection.

In an alternative embodiment to that above, the support frame contains, in addition to the connecting elements, a mechanical interface, and in the mounted state in the cell-contacting system the support frame is fastened at least partially by means of the interface mechanically on the cell connectors or another structure of the CCS and consequently in the cell-contacting system. There is additional mechanical fastening, for example, by the connecting elements.

In a preferred variant of the said embodiment, the mechanical interface is configured for fastening to a cell connector for the intended purpose and/or the abovementioned support structure supporting the cell connectors. According to the above explanations, the cell connector is thus known in terms of its geometry, properties, etc. and the interface is specifically designed to fulfill a retaining function for the support frame together with the cell connector, for example by dimensioning a form or friction fit, for example a clasped connection, an undercut, a clamped connection, an interlocking connection, etc.

In a preferred variant of the embodiment, the mechanical interface is configured for fastening to a cell connector for the intended purpose and/or the support structure by it being configured as a plug-on holder for plugging the support frame onto a mating structure for the intended purpose on the cell connector. The mating structure is, for example, a sheet-like tongue or tab, with known dimensions (see above), on the cell connector. The support frame or the interface can then be plugged onto the mating structure for fastening and be held there securely in particular by a correspondingly dimensioned friction fit or form fit.

In a preferred embodiment, the electronic component contains a temperature sensor which is attached firmly to the printed circuit board. In particular, it is arranged such that it directly contacts one of the cell connectors in a thermally conductive fashion in the mounted state, i.e. when mounted for the intended purpose in relation to a cell-contacting system for the intended purpose. “Directly” means at least with the interposition of a thermally conductive paste/film or the like, but not so far away from the cell connector that it would be necessary for the temperature to be transmitted to the sensor over a distance, for example by means of a heat conduction plate or the like. Temperature can thus be measured directly with the aid of the plate directly at the cell connector.

In a preferred embodiment, the electronic component contains an alternative temperature sensor which is configured as or in a unit which is separate from the printed circuit board. The unit can be connected or is connected in the mounted state electrically to the printed circuit board. Thus, in the mounted state, the printed circuit board can be situated at any desired location relative to a desired measuring point of a temperature. Then it is only necessary to place (remote from the printed circuit board) the unit, for example a separate printed circuit board with a temperature sensor, at the measuring point. The unit is then connected to the printed circuit board via a signal line/radio link/communications channel/etc. for transmitting the temperature information (not the temperature itself). The temperature information is then, for example a voltage/current/resistance etc. correlated with the temperature.

In a preferred embodiment, the electronic component has connecting elements for precisely two cell connectors. The electronic component thus serves to evaluate the state of a battery with reference to precisely two of its cell connectors. Thus, for example, the voltage of an individual battery cell or its temperature, its impedance, power output, etc. can be calculated. Thus, in a whole battery, a series of such electronic components can be placed and connected to one another in a communicating fashion in order to be able to manage the whole battery.

In an alternative embodiment, the electronic component has connecting elements for at least three, in particular all the cell connectors of a cell-contacting system for the intended purpose. Thus, an evaluation of relatively complex relationships in the CCS and, in the mounted state and when in operation, the battery can be calculated already at the level of the printed circuit board. Thus, for example, a single printed circuit board is sufficient for carrying out all the monitoring or even management of the battery.

The object of the invention is also achieved by a cell-contacting system according to independent cell-contacting system patent claim. The cell-contacting system and at least some of its embodiments and the respective advantages have already been explained analogously in conjunction with the electronic component according to the invention. The cell-contacting system contains a plurality of cell connectors which serve for the power contacting of battery cells, and at least one electronic component according to the invention. In a corresponding cell-contacting system, the number, position, form, geometry, relative position to one another, etc. of cell connectors and other structural parts are known. In particular, it is thus possible to adapt an electronic component to a specific cell-contacting system and not just one for the intended purpose.

The object of the invention is also achieved by a method according to the independent method patent claim for producing a cell-contacting system according to the invention. In the method, the electronic component according to the invention is supplied with a printed circuit board not yet inserted into the holder. First, the electrical connecting elements of the electronic component (without the printed circuit board) are then connected electrically to the cell connectors. Next, the printed circuit board is inserted into the holder with the plug-in sockets contacting the plug-in contacts. Thermal and mechanical stress on the printed circuit board during the mounting of the cell-contacting system itself (still without the printed circuit board) is thus avoided.

The object of the invention is also achieved by a method according to the independent method claim for producing a battery module. The battery module contains a battery and a cell-contacting system according to the invention contacting the battery. In the method, the electronic component according to the invention is supplied with the printed circuit board not yet inserted into the holder. First, the electrical connecting elements of the electronic component (without the printed circuit board) are electrically connected to the cell connectors. (Beforehand, at the same time, or later) the cell-contacting system, possibly completed, is moreover connected to the battery. After this step, i.e. next, the printed circuit board is inserted into the holder with the plug-in sockets contacting the plug-in contacts. Thermal and mechanical stress on the printed circuit board during the mounting of the cell-contacting system and also the mounting on the battery is thus avoided.

The invention is based on the following insights, observations, and considerations and has the following embodiments. The embodiments are here also referred to, in a partly simplified fashion, as “the invention”. The embodiments can here also contain parts or combinations of the abovementioned embodiments or correspond to them and/or possibly also include embodiments not already mentioned.

The printed circuit board can be configured as a rigid PCB (it can alternatively also be a flex or rigid-flex PCB). The support frame is in particular a plastic frame for holding the printed circuit board. The plug-in contacts in the form of press-fit pins are in particular embedded in the plastic frame (the pins can also be PTH pins). They are in particular copper pins for a special aluminum/copper laser connecting process. Central pins of the printed circuit board are in particular joined directly to the cell connectors. Indirect joining of the printed circuit board to the cell connectors via connecting elements which contain forks with wire (copper enameled wire) is possible. The holder for the printed circuit board or the support frame is in particular first mounted in the CCS. Then, connections to the CCS or the cell connectors (copper enameled wire/connection by laser welding) are established. Finally, the printed circuit board is mechanically and electrically connected in one step by being pushed onto the plug-in contacts (for example, press-ft pins).

The printed circuit board is connected to the housing (support frame/holder) via plug-in contacts or press-fit pins (alternatively, also via additional plastic elements). The printed circuit board is electrically connected to the cell connectors via plug-in contacts or press-fit pins and connection by laser welding.

The structure of the support frame or the holder (PCB housing) is in particular designed such that: 1. the housing is mounted on the cell connectors, 2. the CCS is completely assembled, 3. the electrical connection of the plug-in contacts (press-fit pins) to the cell connectors is established, and 4. the printed circuit board is mounted by being pressed into the housing (support frame, holder).

The printed circuit board is thus connected to the CCS in a final mounting step. There is here minimal stress on the PCB from the use of the plugging technique (press-fit technology). Installation of a rigid PCB in a “breathing” CCS (thermal/mechanical movements of the components relative to one another) is possible as a result of the use of resiliency (as explained above) in the form of wire (for example, copper enameled wire). Thanks to the communications interfaces, it is possible to create a bus system inside the CCS/module, in particular by the use of wire (for example, copper enameled wire).

A CCS for long-term stable operation results from the use of the plug-in technique (press-fit pins) with integrated tolerance and length compensation.

Other features which are considered as characteristic for the invention are set forth in the appended claims.

Although the invention is illustrated and described herein as embodied in an electronic component for a cell-contacting system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of an electronic component;

FIG. 2 is a perspective view showing a cell-contacting system with two electronic components according to FIG. 1;

FIG. 3 is a plan view of an alternative electronic component;

FIG. 4 is a perspective view of the electronic component from FIG. 3; and

FIG. 5 is a plan view of an alternative cell-contacting system with three electronic components according to FIGS. 3 and 4.

### DETAILED DESCRIPTION OF THE INVENTION

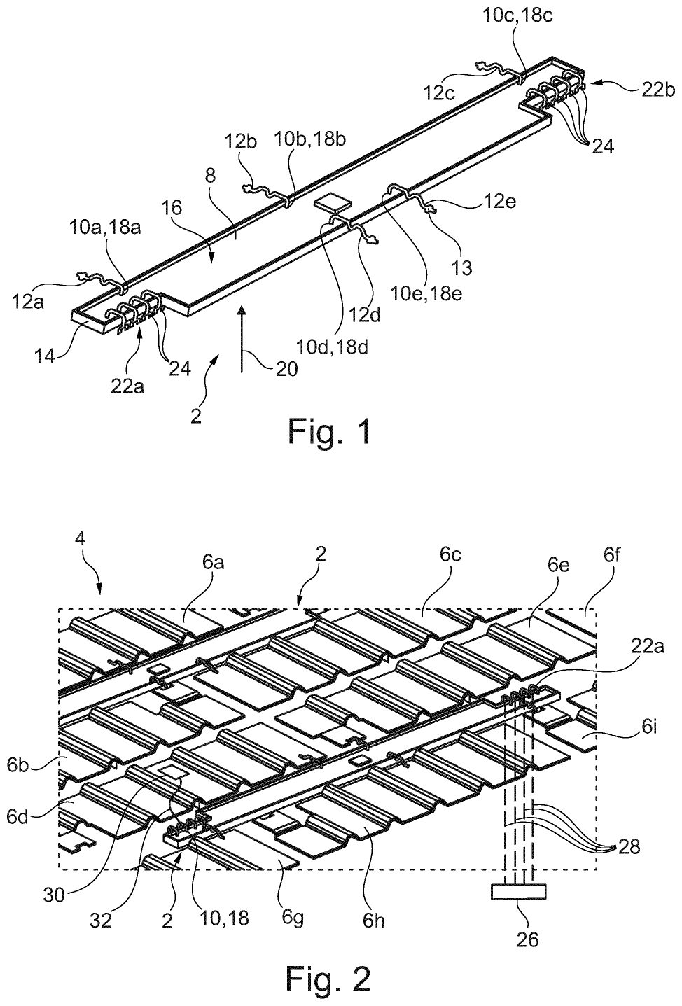

Referring now to the figures of the drawings in detail and first, particularly to FIG. 1 thereof, there is shown an electronic component 2 for a cell-contacting system 4.

FIG. 2 shows two of the electronic components 2 from FIG. 1 in their mounted state in the cell-contacting system 4. The cell-contacting system 4 contains a plurality of cell connectors 6, nine (6a-i) of which can be seen in FIG. 2. The cell connectors 6a-i serve for power contacting battery cells (not illustrated in the figures) of a battery. In the final mounting process (not illustrated) of a battery system, the cell-contacting system 4 is mounted on the battery by, inter alia, the cell connectors 6a-i being welded to the battery poles.

The electronic component 2 contains a printed circuit board 8. This is part of a management arrangement (not illustrated in detail in the figures) for implementing battery management at the battery whilst it is operating. The printed circuit board 8 contains in the example five plug-in sockets 10a-e (not visible in more detail in the figures), in this case in the form of PTHs, i.e. metal-plated through bores. The plug-in sockets 10a-e serve to electrically connect the printed circuit board 8 to the cell connectors 6a-i via in this case five respective connecting elements 12a-e. The connecting elements 12a-e are also part of the electronic component 2.

The electronic component 2 moreover contains a support frame 14, in this case a plastic frame, which has a holder 16 for the printed circuit board 8. The holder 16 is here a trough-shaped or shell-like holding space which is surrounded or formed by the plastic frame. The printed circuit board 8 is already inserted into the holder 16 in FIGS. 1 and 2.

Each of the connecting elements 12a-e is here configured as unipolar and has a plug-in contact 18a-e at its respective end facing the printed circuit board 8 in the mounted state. The plug-in contacts 18a-e are also not visible in FIGS. 1 and 2 because they have already been plugged completely into the plug-in sockets 10a-e. The plug-in contacts 18a-e are press-fit pins in the exemplary embodiment. The combination of press-fit pins and PTHs enables both electrical contacting and also mechanically firm retention between the connecting element 12a-e and the printed circuit board 8. All of the plug-in contacts 18a-e are in each case mechanically firmly embedded in the support frame 14, this not being illustrated in FIGS. 1 and 2 for the sake of clarity.

The following is thus possible: the printed circuit board 8 is mounted in the support frame 14 or in the holder 16 or is introduced therein by it being inserted into the support frame 14/the holder 16 in the direction of the arrow 20. Because the connecting elements 12a-e and hence also their ends configured as plug-in contacts 18a-e are fastened firmly to the support frame 14, they are thus simultaneously pushed into the plug-in sockets 10a-e of the printed circuit board 8 and thus establish a respective electrical contact and a mechanical connection. In other words, the printed circuit board 8 can thus be inserted into the support frame 14 or the holder 16 in the direction of the arrow 20, wherein the introduction takes place with simultaneous plugging or plugging-in or insertion of the plug-in contacts 18a-e into the plug-in sockets 10a-e.

In the example, the printed circuit board 8 moreover has two communications interfaces 22a-b which are likewise part of the electronic component 2. Each of the communications interfaces 22a,b is here configured in the form of four wire holders 24, in this case tuning fork contacts or clamping forks, connected to the printed circuit board 8. The tuning fork contacts are also encapsulated in the support frame 14 or held mechanically firmly therein and have plug-in contacts for corresponding plug-in sockets in the printed circuit board 8. Each of the wire holders 24 serves to hold an only symbolically indicated connecting wire 28, in this case, for example, a copper enameled wire, so that it is electrically contacted and mechanically fastened. Communication then takes place via the corresponding connecting wire 28 as an electrical communication line/communications medium for data exchange with a remote station 26 which is indicated only symbolically in the figures and in this case is an external management unit for the battery.

In the example, the connecting elements 12a-e are one-piece direct connectors between the printed circuit board 8 and the respective cell connector 6a-i.

In the example, the support frame 14 is mechanically retained in the cell-contacting system 4 only via the connecting elements 12a-e and only on the cell connectors 6a-i and/or a support structure (not illustrated) supporting the cell connectors 6a-i. The printed circuit board 8 is also mechanically fixed in the holder 16 via the connection of the plug-in sockets 10a-e to the plug-in contacts 18a-e. Additional positive retention is moreover effected by the printed circuit board 8 being bordered by the support frame 14.

In the exemplary embodiment, the printed circuit board 8 is configured as a multiple printed circuit board (multi-cell chip), i.e. it is designed for more than two, in this case namely five cell connectors 6d,e,g,h,i (for the printed circuit board 8 visible “at the front of the drawing) and can thus detect its five, possibly different potentials or other parameters. For a battery system with, for example, fifteen cell connectors, thus only three electronic components 2 with such printed circuit boards 8 would be required.

In the final mounted state (not illustrated), the CCS 4 is mounted on the battery. The signal lines (in this case implemented by the connecting elements 12a-e) of the individual potential level (for example, potentials of the contacted cell connectors 6d,e,g,h,i) of the battery system are then combined on the individual printed circuit board 8 (in this case a PCB, alternatively also a flex/rigid-flex PCB). The potential levels, converted into a digital signal, are relayed there, in this case to the remote station 26, by means of the communications interfaces 22a,b via a data transmission system (BUS, bus system 44, in this case the connecting wires 28). The electronic components required for this are situated on the printed circuit board 8. The printed circuit board 8 is inserted into a plastic frame, namely the support frame 14, in which the connecting elements 12a-e or the plug-in contacts 18a-e, in this case press-fit pins (or PTH pins) are embedded. These pins (plug-in contacts 18a-e) are directly connected to the cell connectors 6d,e,g,h,i via the one-part connecting elements 12a-e.

In an alternative embodiment which is not illustrated, the connecting elements 12a-e are configured with multiple parts. The plug-in contacts 18a-e are then connected indirectly to the cell connectors 6d,e,g,h,i via forks and copper enameled wiring, as indicated in the example for the communications interfaces 22a,b.

The method for producing the cell-contacting system 4 is configured such that the holder 16 of the printed circuit board 8/support frame 14 in the form of the plastic frame is mounted first. Next, the connections in the CCS are established by connecting the connecting elements 12a-e, alternatively the said wiring (not illustrated), to the embedded press-fit pins (plug-in contacts 18a-e). Finally, the printed circuit board 8 is connected mechanically and electrically in one step to the holder 16 or the support frame 14 by being pushed onto the press-fit pins, i.e. the plug-in contacts 18a-e.

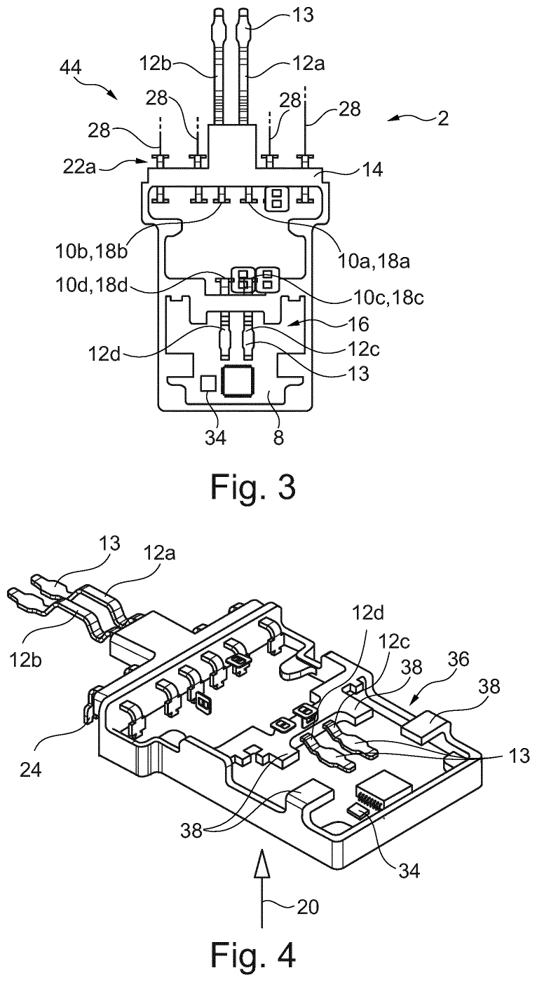

A distinction is made between a plurality of printed circuit boards (single-cell chip) which are in each case situated between two successive potentials (see FIGS. 3-5) and a multiple printed circuit board or printed circuit board panel (multi-cell chip) which detect more than two or all of the potentials present in the battery system (see FIGS. 1-2).

The “multi-cell chip” variant taps the signal for temperature measurement via a separately configured sensor 30, in this case an NTC PCB (NTC: temperature sensor, negative temperature coefficient), and relays it to the printed circuit board 8 via a supply line 32, in this case a copper enameled wire. Data transmission is effected for both variants by the communications interfaces 22a,b via BUS links. Contacting of the printed circuit board 8 by plug-in contacts 18a-e in the form of special copper pins enables the application of a laser welding process in order (in the case of aluminum cell connectors 6) to produce a standard aluminum/copper welded connection at the connection point between the cell connector 6 and the connecting element 12.

According to FIGS. 1 and 2, multi-cell/(FIGS. 3-5: single-cell) electronics (electronic component 2 and printed circuit board 8) with temperature/voltage measurement and balancing on the cell connector 6 thus result.

The tuning fork contacts of the communications interfaces 22a,b are also formed on the printed circuit board 8 as plug-in contacts. Here too, the printed circuit board 8 is contacted only when it is plugged onto corresponding plug-in contacts (not labeled separately in the figures).

The welding between the connecting elements 12 and the cell connectors 6 is effected in each case at the location 13, widened in the manner of a plate, of the connecting elements 12.

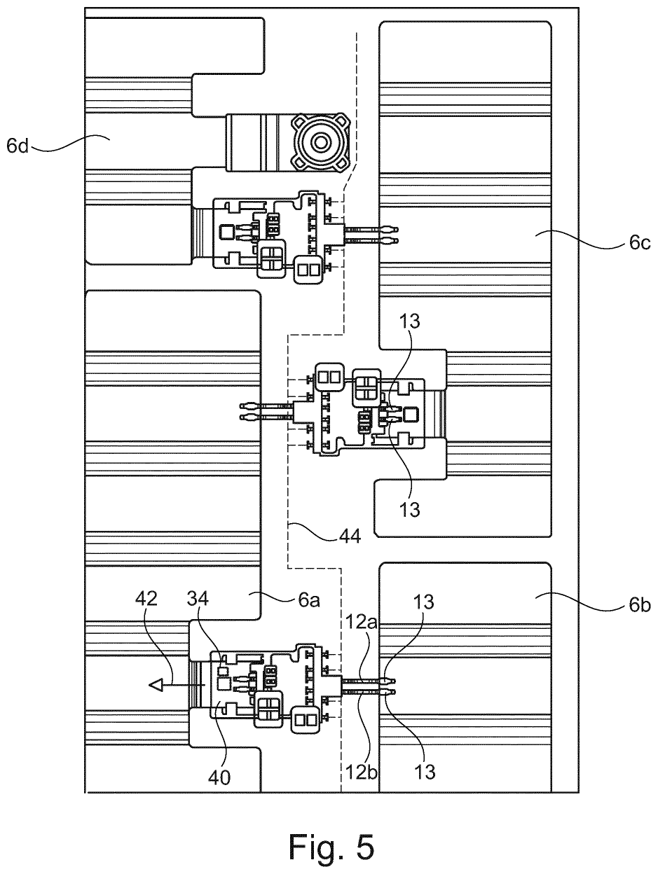

FIGS. 3 to 5 show an alternative embodiment of an electronic component 2 and a cell-contacting system 4 (FIG. 5, battery once again not illustrated). A total of four cell connectors 6a-d and three electronic components 2 are contained here.

The electronic component 2 is configured here as a “single-cell chip” variant (contacts only two cell connectors 6 in each case) and rests directly against one of the cell connectors 6a,c,d and taps the temperature of the cell connector 6a,c,d via an integrated temperature sensor 34 (NTC, indicated symbolically). Two successive potentials (of second cell connectors 6b to 6a, 6a to 6c, and 6c to 6d) are routed via connecting elements 12a,b (configured as long press-fit pins) to the next potential (cell connectors 6a,c,d). It is thus also possible to measure the impedance. The connecting elements here have the resiliency explained above, caused here (see in particular FIG. 4) because they run in an S-shape between the locations 13 and the support frame 14.

Visible and illustrated here in particular in FIGS. 3 and 4, in contrast to FIGS. 1 and 2, is the mechanically firm embedding of the connecting elements 12 and the corresponding structures of the communications interfaces 22a,b in the support frame 14. Firm embedding forms a suitable starting point for successfully plugging the plug-in sockets 10 onto the plug-in contacts 18 when the printed circuit board 8 is introduced into the holder 16.

The arrangement is explained here by way of example with the aid of one electronic component 2 between the cell connectors 6a,b.

Here too, the electronic component comprises the support frame 14 with a holder 16, wherein four connecting elements 12a-d are mechanically firmly embedded in the support frame 14. Just one communications interface 22a with a total of four tuning fork contacts for wire connections is included here per printed circuit board 8. The printed circuit board is also plugged into the holder 16 of the support frame 14 in the direction of the arrow 20.

However, the support frame 14 here includes a mechanical interface 36. In the mounted state in FIG. 5, the support frame 14 is mechanically fastened to the cell connectors 6, and consequently in the whole cell-contacting system 4, by means of the interface 36. For this purpose, the interface 36 has a total of four tabs 38 which engage around a mating structure 40, in this case a tab of the cell connector 6, and consequently effect mechanical fastening. The support frame 14 is pushed onto the mating structure 40 in the direction of the arrow 42 in order to mount it.

The temperature sensor 34 here also comes into contact with the mating structure 40, i.e. the metal tab as an extension of the cell connector 6, such that the temperature of the cell connector 6 can be measured directly.

According to FIGS. 3-5, a printed circuit board 8 thus results in the form of a rigid PCB with a single-cell chip with integrated temperature measurement and impedance measurement.

The arrangement of the temperature sensor (chip) is situated below the cell connector 6a. The temperature of the cell connector 6a is detected by the temperature sensor 34 (actual sensor integrated into the chip) via a medium (not illustrated, adhesive or paste or rubber, with or without improved thermal conductivity). A hole (not visible in the figures) in the printed circuit board 8 is situated below the temperature sensor 34 (chip) in order to reduce the dissipation of heat via the metallization of the printed circuit board 8. The actual temperature measurement is effected via the chip surface (facing the underside of the cell connector 6a) of the temperature sensor 34.

It is possible to measure the impedance via the two connecting elements 12a,b and 12c,d per cell connector 6a and 6b.

According to FIG. 5, there is a single-cell control system for a cell-contacting system 4 completed correspondingly by a battery (not illustrated): an electrical connection (link/control link logic) is effected by a bus system 44 (connection to the communications interface 22a) to the respective next single-cell chip (printed circuit board 8) via in this case a copper enameled wire (welding forks, etc), in the example a four-core bus consisting of four connecting wires 28.

The following is a summary list of reference numerals and the corresponding structure used in the above description of the invention.

### LIST OF REFERENCE SIGNS

2 electronic component
4 cell-contacting system
6a-i cell connector
8 printed circuit board
10a-e plug-in socket
12a-e connecting element
13 location
14 support frame
16 holder
18a-e plug-in contact
20 arrow
22a,b communications interface
24 wire holder
26 remote station
28 connecting wire
30 sensor
32 supply line
34 temperature sensor
36 interface (mechanical)
38 tab
40 mating structure
42 arrow
44 bus system

1. An electronic component for a cell-contacting system, the cell-contacting system having a plurality of cell connectors serving for power contacting of battery cells of a battery, the electronic component comprising:
a printed circuit board of a measuring and/or management configuration for the battery, said printed circuit board having plug-in sockets for electrical connection to the cell connectors;
at least one support frame having a holder for said printed circuit board;
a plurality of electrical connecting elements for a respective electrical connection of said printed circuit board to the cell connectors, each of said electrical connecting elements having a plug-in contact being plugged in an electrically contacting manner to one of said plug-in sockets;
each said plug-in contact being embedded in said at least one support frame and consequently fastened thereto;
said printed circuit board being inserted into said holder by plugging said plug-in sockets to said plug-in contacts; and
said printed circuit board having at least one communications interface for a data exchange of information with a remote station.

2. The electronic component according to claim 1, wherein at least one said plug-in contact is a press-fit pin or a plated through hole pin.

3. The electronic component according to claim 1, wherein at least one of said electrical connecting elements is a one-piece direct connector between said printed circuit board and a cell connector of the cell connectors.

4. The electronic component according to claim 1,
further comprising a connecting wire; and
wherein at least one of said electrical connecting elements is configured with multiple parts and contains a fixed section, facing said printed circuit board, with said plug-in contact, and a wire section facing a cell connector and contains at least one wire holder, connected to said fixed section, for said connecting wire and said connecting wire leading from said at least one wire holder to the cell connector.

5. The electronic component according to claim 1, wherein said at least one support frame is fastened in a mounted state in the cell-contacting system only by means of said electrical connecting elements mechanically on the cell connectors and/or on a support structure which supports the cell connectors, and consequently is fastened in the cell-contacting system.

6. The electronic component according to claim 1, wherein said at least one support frame contains, in addition to said electrical connecting elements, a mechanical interface, and in a mounted state in the cell-contacting system said at least one support frame is fastened at least partially by means of said mechanical interface mechanically on the cell connectors and consequently in the cell-contacting system.

7. The electronic component according to claim 6, wherein said mechanical interface is configured for fastening to a cell connector of the cell connectors for an intended purpose and/or a support structure supporting the cell connectors.

8. The electronic component according to claim 7, wherein said mechanical interface is configured for fastening to a cell connector of the cell connecters for an intended purpose and/or the support structure by it being configured as a plug-on holder for plugging said at least one support frame onto a mating structure for the intended purpose on the cell connector.

9. The electronic component according to claim 1, further comprising a temperature sensor being attached firmly to said printed circuit board.

10. The electronic component according to claim 1, further comprising a temperature sensor configured as a unit which is separate from said printed circuit board and is connected electrically to said printed circuit board.

11. The electronic component according to claim 1, wherein a number of said electrical connecting elements is provided for precisely two said cell connectors.

12. The electronic component according to claim 1, wherein a number of said electrical connecting elements is provided for precisely three said cell connectors.

13. A cell-contacting system, comprising:
a plurality of cell connectors which serve for power contacting battery cells; and
at least one electronic component according to claim 1.

14. A method for producing a cell-contacting system, which comprises the steps of:
providing a plurality of cell connectors which serve for power contacting battery cells;
providing an electronic component according to claim 1 with the printed circuit board not yet inserted into the holder;
electrically connecting the electrical connecting elements to the cell connectors; and
subsequently inserting the printed circuit board into the holder with the plug-in sockets contacting the plug-in contacts.

15. A method for producing a battery module, which comprises the steps of:
providing a battery having battery cells;
providing a cell-contacting system having a plurality of cell connectors which serve for power contacting the battery cells;
providing an electronic component according to claim 1 with the printed circuit board not yet inserted into the holder;
electrically connecting the electrical connecting elements to the cell connectors;
connecting the cell-contacting system to the battery; and
subsequently inserting the printed circuit board into the holder with the plug-in sockets contacting the plug-in contacts.
